(19) United States
(12) Patent Application Publication
(10) Pub. No.: US 2006/0224502 A1
(43) Pub. Date: Oct. 5, 2006

(54) System and method for online peer-to-peer banking

(76) Inventor: Adam McGowan, Boston, MA (US)

Correspondence Address: AKC PATENTS, 215 GROVE ST., NEWTON, MA, 02466, US

(21) Appl. No.: 11/394,035

(22) Filed: Mar. 30, 2006

Related U.S. Application Data
(60) Provisional application No. 60/667,130, filed on Mar. 31, 2005.

(51) Int. Cl. G06Q 40/00

(52) U.S. Cl. 705/38

(57) ABSTRACT

A method for providing a peer-to-peer loan service includes providing a website, listing lenders and amount of capital offered to be loaned and loan terms for each of the lenders in a lender database, placing a bid for a desired loan amount and desired loan terms by a borrower in the website, identifying at least one lender who can meet the borrower's bid, communicating this information to the borrower and reaching of equilibrium agreement between the at least one lender and the borrower. The equilibrium agreement is reached via an auction process and/or an algorithm process.

### CROSS REFERENCE TO RELATED CO-PENDING APPLICATIONS

This application claims the benefit of U.S. provisional application Ser. No. 60/667,130 filed on Mar. 31, 2005 and entitled SYSTEM AND METHOD FOR ONLINE PEER-TO-PEER BANKING which is commonly assigned and the contents of which are expressly incorporated herein by reference.

### FIELD OF THE INVENTION

The present invention relates to a system and a method for online peer-to-peer banking and in particular to an auction and/or algorithm based online peer-to-peer banking between individuals or institutions.

### BACKGROUND OF THE INVENTION

Peer-to-peer online services are the next wave of evolution of the Internet. Internet based music sharing services, peer-to-peer computing and online auctions are examples of these peer-to-peer online services. One area where peer-to-peer online services could be useful is financial services and in particular banking and lending.

Traditionally, lending/borrowing services are offered through banks, credit card companies and other financial institutions. These financial institutions usually borrow money from consumer deposits at low rates (e.g. 3%) and then lend it out at high rates (e.g. 18%). This process is expensive for the person borrowing money from the institution and not very rewarding for the person depositing money in the institution. Furthermore, the lending/borrowing process through the financial institutions is heavily regulated and highly exclusive.

Physical peer-to-peer (or person-to-person) lending/borrowing is a known lending/borrowing method that is usually practiced among people belonging to the same group such as family members, religious groups, ethnic groups, professional groups, and any other community of people that know each other. The virtual community of the World Wide Web has brought people together and has facilitated direct and indirect commercial online exchanges among people that do not necessarily belong to the above mentioned traditional groups. These online commercial exchanges currently include selling, buying, paying, and auctioning. The cost of performing these exchanges has been reduced online and this has resulted into a benefit both for the sellers and the buyers. Lending/borrowing money requires a high level of trust among people which is difficult to assess and evaluate for the online community of people. However, the large difference between the lending and borrowing rates presents an attractive opportunity for a cost reduction and a potential benefit for both borrows and lenders.

### SUMMARY OF THE INVENTION

In general in one aspect, the invention features a method for providing a peer-to-peer loan service including the steps of providing a website, listing one or more lenders and amount of capital offered to be loaned and loan terms for each of the one or more lenders in a lender database, placing a bid for a desired loan amount and desired loan terms by a borrower in the website, identifying at least one lender among the one or more lenders who can meet the borrower's bid and communicating information of the at least one lender to the borrower, selecting the at least one lender by the borrower and notifying the selected at least one lender of the borrower's bid and reaching of equilibrium agreement between the at least one lender and the borrower. The term bid refers to both a conventional auction bid and/or a request.

Implementations of this aspect of the invention may include one or more of the following features. The website is accessible via a network connection and comprises a plurality of interlinked webpages stored in a memory and the memory is couple to a computing circuit and to a communications interface for communicating via the network connection; The method further includes accepting the borrower's bid by the at least one lender. The loan terms include interest rate, maximum payback period of loan, repayment terms (e.g. scheduled payment of interest or payment in full) and interest rate fluctuations. The identifying of at least one lender who can meet the borrower's bid occurs via an algorithm or auction. The algorithm receives input variables including lender's lowest acceptable loan amount, borrower's dynamic risk level based on credit rating and prior feedback, borrower's desired loan amount, borrower's highest potential interest rate, lender's desired payback period of loan, or lender's credit rating and prior feedback. The algorithm further provides loan interest rates based on a risk assessment calculation. The algorithm performs calculation steps including identifying the borrower, determining desired loan amount, desired loan terms, and borrower's credit rating, searching the lender database and extracting all lenders with sufficient amount of capital meeting the desired loan amount, desired loan terms, and borrower's credit rating, ranking lenders meeting the desired loan amount, desired loan terms, and borrower's credit rating, and presenting the ranked lenders to the borrower. The reaching of equilibrium between the at least one lender and the borrower occurs via an auction process. The auction process includes receiving and posting the borrower's bid, receiving and posting additional bids from other borrowers for the desired loan amount and the desired loan terms, closing of the bidding process after a pre-disclosed period of time, and determining a winning bid based on criteria including greatest interest payment to lender, greatest net benefit going to both borrower and lender as compared to current interest rates, loan terms, loan amount or credit ratings or feedback of borrowers. The method further includes collecting information about the lenders and the borrower and pre-approving the lenders and the borrower for participating in the peer-to-peer loan service. The collected information includes credit rating, feedback from previous transactions, employment records, health records, residency records, personal assets, educational records, or professional records. The method further includes presenting a contract for the peer-to-peer loan service to the borrower and the at least one lender. The method further includes collecting funds for the loan amount from the at least one lender and upon signing the contract by both the borrower and the at least one lender, distributing the funds to the borrower. The method further includes keeping track of all financial transactions comprising the collection and distribution of funds, repayment of the funds plus interest from the borrower to the at least one lender, and transaction costs. The method further includes receiving the funds by the borrower via a credit card, check, direct deposit in a bank account, wire in a bank account or deposit in an electronic account. The method further includes providing feedback for the borrower and the at least one lender. The website includes a user secure log in webpage, a user secure sign up webpage, a company information webpage, a contact information webpage, and a user welcome webpage. The user welcome webpage has links to user's account information webpage, track transactions webpage, borrow webpage and lend webpage. The user's account information webpage includes user's contact information, credit card information, bank account information, electronic account information, credit rating and feedback. The track transaction webpage contains all open and closed transaction information. The borrow webpage and the lend webpage include links to an auction based process and an algorithm based process. The method may further comprise providing a loan guarantor for the loan.

In general, in another aspect, the invention features a system for providing a peer-to-peer loan service including a website, means for listing and searching one or more lenders and amount of capital offered to be loaned and loan terms for each of the one or more lenders in a lender database, means for placing a bid for a desired loan amount and desired loan terms by a borrower in the website, means for identifying at least one lender among the one or more lenders who can meet the borrower's bid and communicating information of the at least one lender to the borrower, means for selecting the at least one lender by the borrower and notifying the selected at least one lender of the borrower's bid, and means for reaching of equilibrium agreement between the at least one lender and the borrower.

### BRIEF DESCRIPTION OF THE DRAWINGS

FIG. 1 is a schematic diagram of an online peer-to-peer banking;

FIG. 2 is a block diagram of one embodiment of an auction driven peer-to-peer banking system;

FIG. 3 is a block diagram of an algorithm driven peer-to-peer banking system;

FIG. 4 is a block diagram of the website detail flow;

FIG. 5 is a continuation of the block diagram of the website detail flow of FIG. 4;

FIG. 6 is a flow diagram of the pre-transaction process;

FIG. 7 is a flow diagram of the algorithm-based transaction process;

FIG. 8 is a flow diagram of the auction based transaction process;

FIG. 9 is a flow diagram of the transaction finalizing process;

FIG. 10 is a flow diagram of the transaction monitoring process; and

FIG. 11 is a flow diagram of the transaction closing process.

### DETAILED DESCRIPTION OF THE INVENTION

The present invention is directed to an online peer-to-peer banking system and method. This novel peer-to-peer banking system provides lending and borrowing services between individuals or institutions through online interactions. The online lending/borrowing is implemented either as an auction process or an algorithm driven matching process. This online peer-to-peer banking system removes the traditional third party (i.e. bank, credit card company) from the lending and/or borrowing process which results in a reduction of the cost of borrowing and an increase in the reward for lending. For example, if John Doe has $1000 that he wishes to invest, the best he can do with regard to a short-term fixed rate of interest is likely 3% from a 1 year certificate of deposit. On the other hand, if Mike Smith needs $1000, he is likely to borrow it on his credit card and pay an interest rate to the tune of 18%.

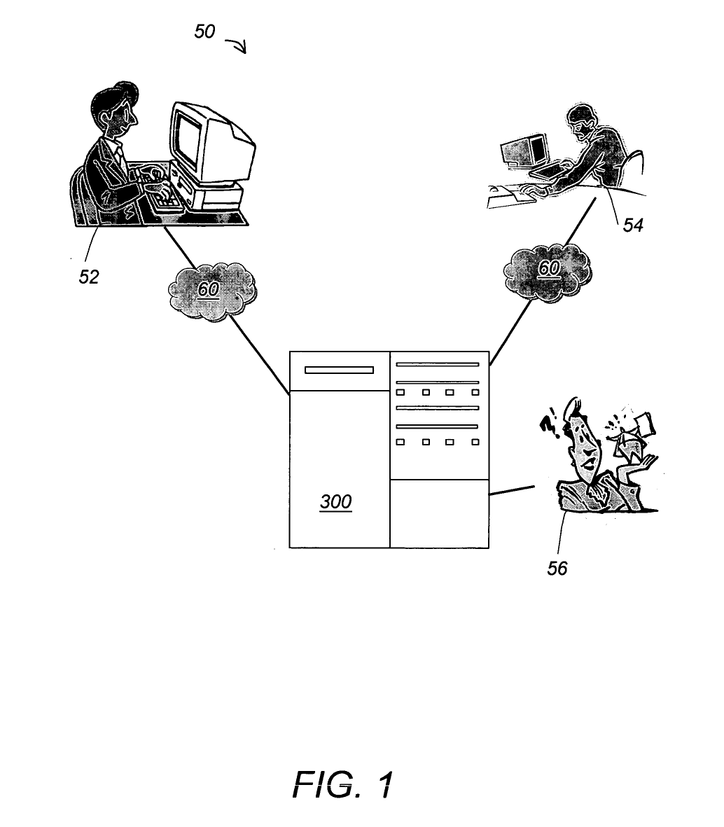

Referring to FIG. 1, in the online peer-to-peer banking system 50, John Doe 54 and Mike Smith 52 both log into a website 300 via a network connection 60 and announce their intentions to invest and borrow money, respectively. John Doe 54 would like to find a borrower (i.e., investment) who is willing to pay greater than 3% for his $1000. Mike Smith 52 would like to find a lender that is willing to lend $1000 for less than 18%. In this example, there is a 15 percentage point differential, where the equilibrium (i.e., agreement) point could fall.

The online peer-to-peer banking system 50 establishes a community of pre-approved users, matches the two (or more) users, provides the mechanism for them to reach an equilibrium point, presents an electronic contract for both to sign, assigns and pays a loan guarantor 56, if necessary, collects the money via electronic debit, disperses the money via electronic transfer or check, keeps track of transaction until all monies are paid back in full plus interest, collects repayment at the loan's end, collects transaction costs, and provides a mechanism for an online rating/feedback for both parties. In one example, the users are pre-approved based on a successful credit check. In other examples, the users are approved based on employment records, health records, residency records, personal assets, or other background information.

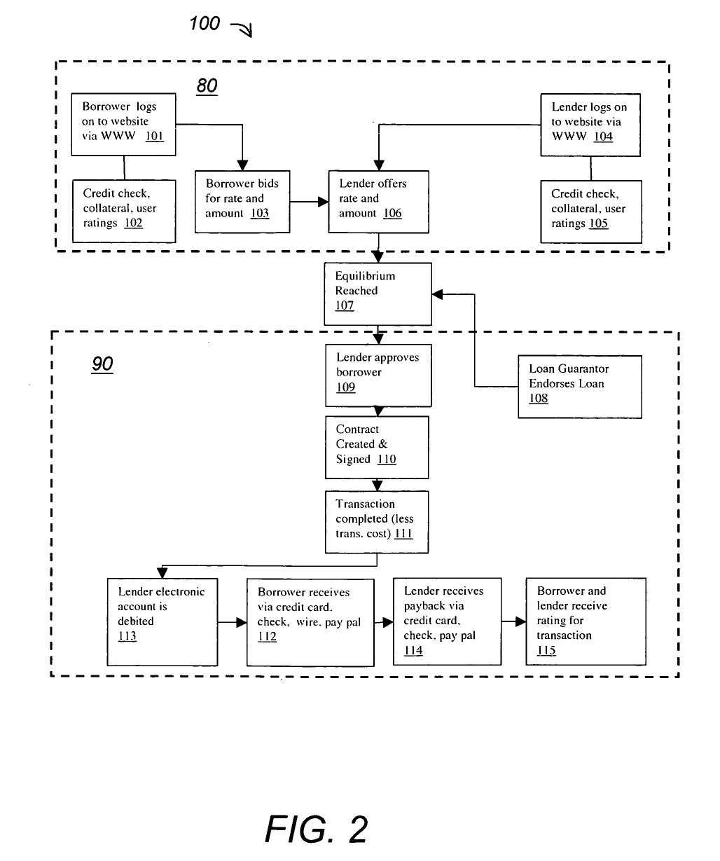

There are at least two ways that the users can interact online to reach an equilibrium point. First, there can be a straight auction where a lender 54 posts his money value available for loan, desired interest rate (starting & reserve), and other terms such as a payback period, desired credit score of borrower, among others. Another user 52 who is looking for a loan can bid accordingly, given the constraints set by the lender as well as the timing of the auction. Referring to FIG. 2, a straight auction based peer-to-peer lending process 100 includes the following steps. A borrower 52 logs on to the banking auction website 300 via a network connection 60 (101). A lender 54 also logs on to the banking auction website 300 via a network connection 60 (104). Both the lender 54 and the borrower 52 go through a credit check, rating and asset assessment, (105), (103), respectively. The lender 54 offers an amount, a rate and terms at which he is interested in lending (106). The borrower 52 places one or more bids for a rate, terms and the amount he is interested in borrowing (103). Equilibrium is reached between the lender 54 and the borrower 52 based on the greatest amount of interest going to the lender, or the greatest net benefit going to both parties as compares to current interest rates, or as otherwise determined (107). A loan guarantor 56 endorses the loan (108) and the lender 54 approves the borrower 52 (109). Next, the system creates a contract based on the information the borrower and the lender provide and the contract is signed by both the borrower and the lender (110). The transaction is completed and a transaction cost is paid to the auction provider (111). The borrower receives the amount via his credit card, check, wire or an electronic account such as a PayPal™ account (112). The lender's electronic account is debited for the lending amount (113). Next, the lender receives payback from the borrower via a credit card, check, wire or PayPal™ account (114). Both the lender and the borrower receive ratings (from one another) for the completed transaction (115).

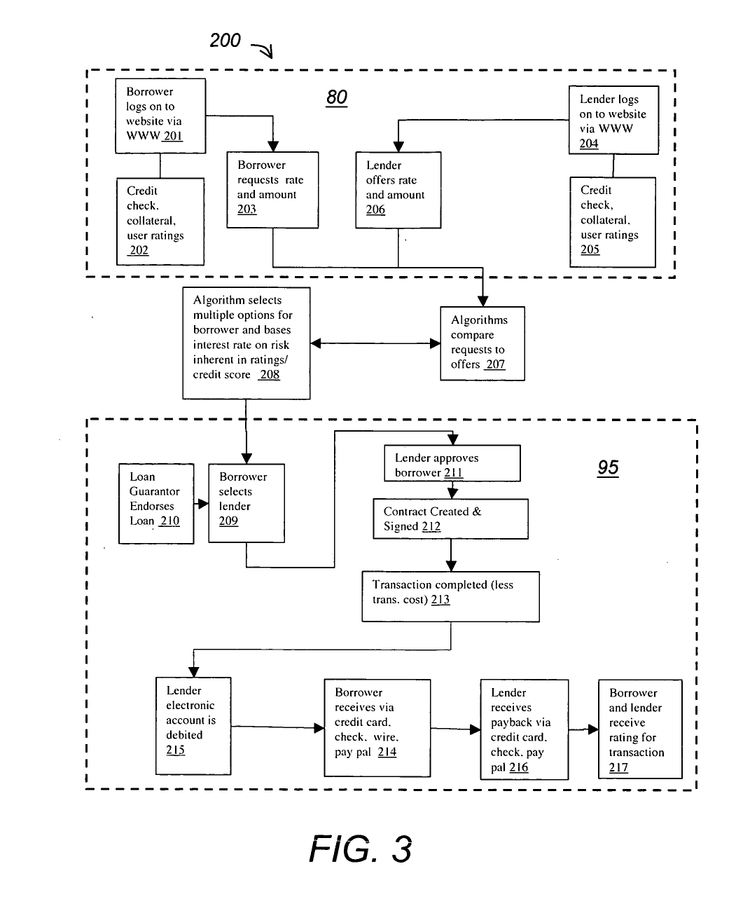

Alternatively, a set of algorithms can automatically match borrowers and lenders given that the online system can take information from the users, such as the lender's lowest acceptable bid/request (i.e., reserve price), loan term, as measured by credit rating and prior feedback, the borrower's requested loan amount, the borrower's dynamic risk level, and the highest potential interest rate the borrower is willing to pay. Referring to FIG. 3, the algorithm based peer-to-peer lending process 200 includes the following steps. A borrower logs on to the banking website 300 via a network connection (201). A lender also logs on to the banking website 300 via a network connection (204). Both the lender and the borrower go through a credit check, rating and asset assessment, (205), (202), respectively. The lender offers an amount, a rate and terms at which he is interested in lending (206). The borrower places one or more bids/requests for a rate, terms and the amount he is interested in borrowing (203). An algorithm compares the bids/requests to all offers (207) and selects multiple options for the borrower (208). A risk assessment algorithm is used to calculate and present interest rates based on risk inherent in the ratings/credit score of the borrower and the lender. The borrower selects a lender (209), a loan guarantor endorses the loan (210) and the lender approves the borrower (211). Next, the system creates a contract based on the information the borrower and the lender provide and the contract is signed by both the borrower and the lender (212). The transaction is completed and a transaction cost is paid to the auction provider (213). The borrower receives the amount via his credit card, check, wire or PayPal™ account (214). The lender's electronic account is debited for the lending amount (215). Next, the lender receives payback from the borrower via a credit card, check, wire or PayPal™ account (216). Both the lender and the borrower receive ratings (from one another) for the completed transaction (217).

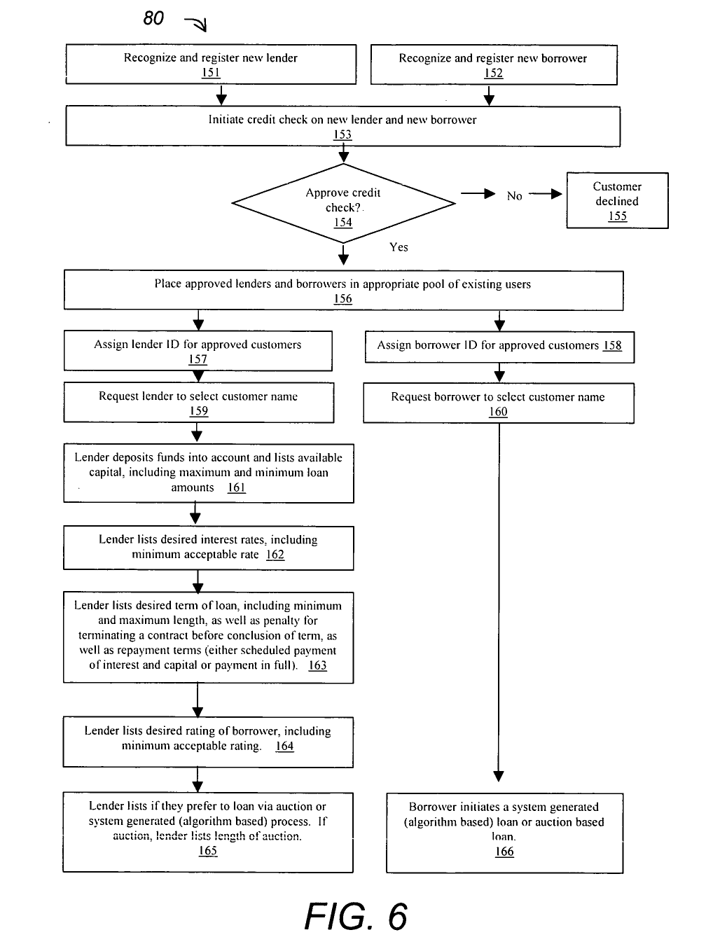

Referring to FIG. 6, in one embodiment the pre-transaction steps 80 in both the auction and the algorithm based transactions include the following:
Recognize and register new lender (151).
Recognize and register new borrower (152).
Initiate credit check on new lender and new borrower (153).
Approve or reject credit check (154).
Assign lender and borrower TD for approved customers (157) (158).
Request lender and borrower to select customer online name (159) (160).
Place approved lenders and borrowers in appropriate pool of existing users (borrowers and lenders).
Lender lists available capital, including minimum and maximum loan Amounts (161).
Lender lists desired interest rates, including minimum acceptable rate (162).
Lender lists desired term of loan, including minimum and maximum length, as well as penalty for terminating a contract before conclusion of term, as well as repayment terms (either monthly payment of interest and capital or payment in full) (163).
Lender lists desired rating of borrower, including minimum acceptable rating (164).
Lender lists if they prefer to loan via auction or system generated (algorithm based) process (165). If auction, lender lists length of auction.
Borrower initiates a system generated (algorithm based) loan or auction based Loan (166).

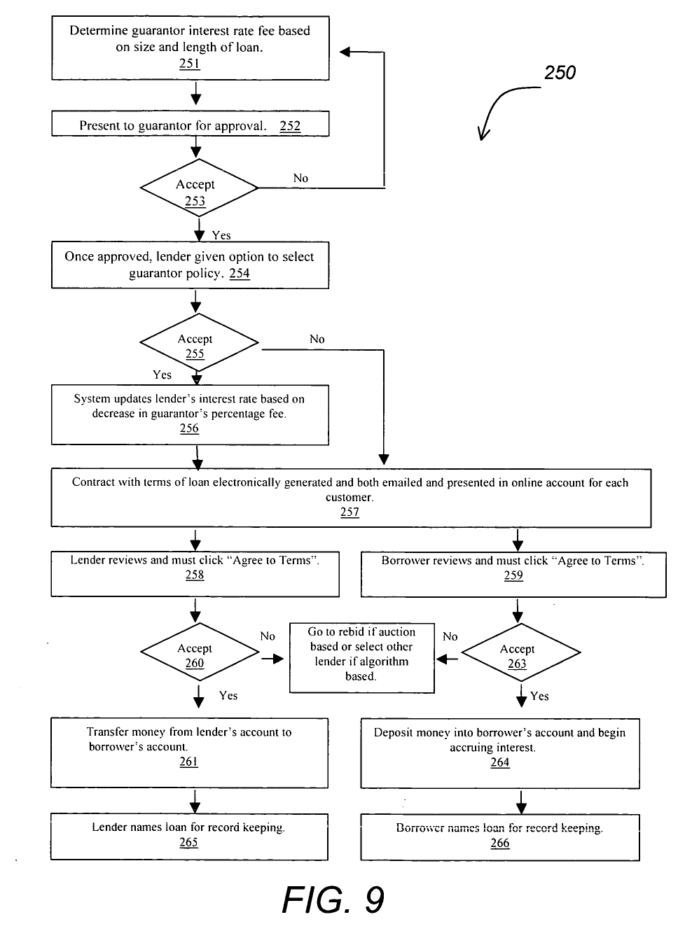

The transaction finalizing, transaction monitoring and transaction closing processes in both the auction and the algorithm based transactions include the following steps. Referring to FIG. 9, the transaction finalizing process 250 includes
Instantaneously, a system calculated, expected guarantor interest rate based on size and length of loan is determined (251) and presented to guarantor for approval or modification (252).
Once approved (253), lender given option to select guarantor (254).
System updates lender's interest rate based on decrease in guarantor's percentage fee (256).
Contract with terms of loan electronically generated and both emailed and presented in online account for each customer (257).
Each customer must review and click “Agree to Terms” (258) (259).
Once both parties agree to loan (260), (263), money is transferred instantly from lender's account to borrower's account and interest begins accruing (261) (264).
Each user is given option to name loan for record keeping (265) (266).

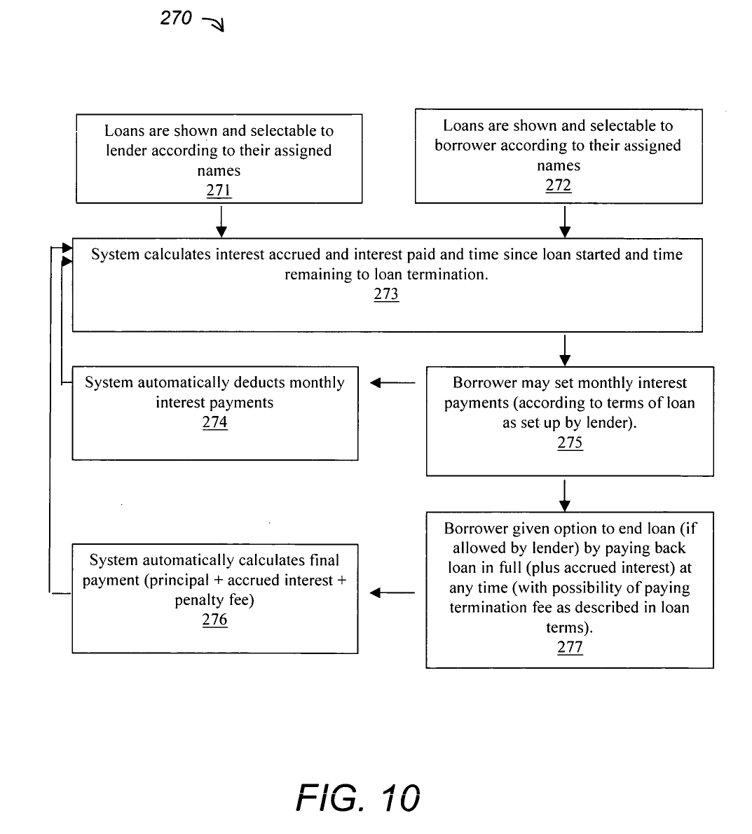

Referring to FIG. 10, the transaction monitoring process 270 includes:
Loans are shown and selectable to borrower and lender according to their assigned names (271) (272).
Loans show other party name, interest accrued and time remaining to loan termination.
System calculates interest rate accrued and interest rate paid and time since loan started and time remaining to loan termination (273).
Borrower may set monthly interest payments (according to terms of loan as set up by lender) (275).
System automatically deducts monthly interest payments (274).
Borrower given option to end loan (if allowed by lender) by paying back loan in full (plus accrued interest) at any time (with possibility of paying termination fee as described in loan terms) (277).
System automatically calculates final payment (principal, accrued interest, penalty fee) (276).

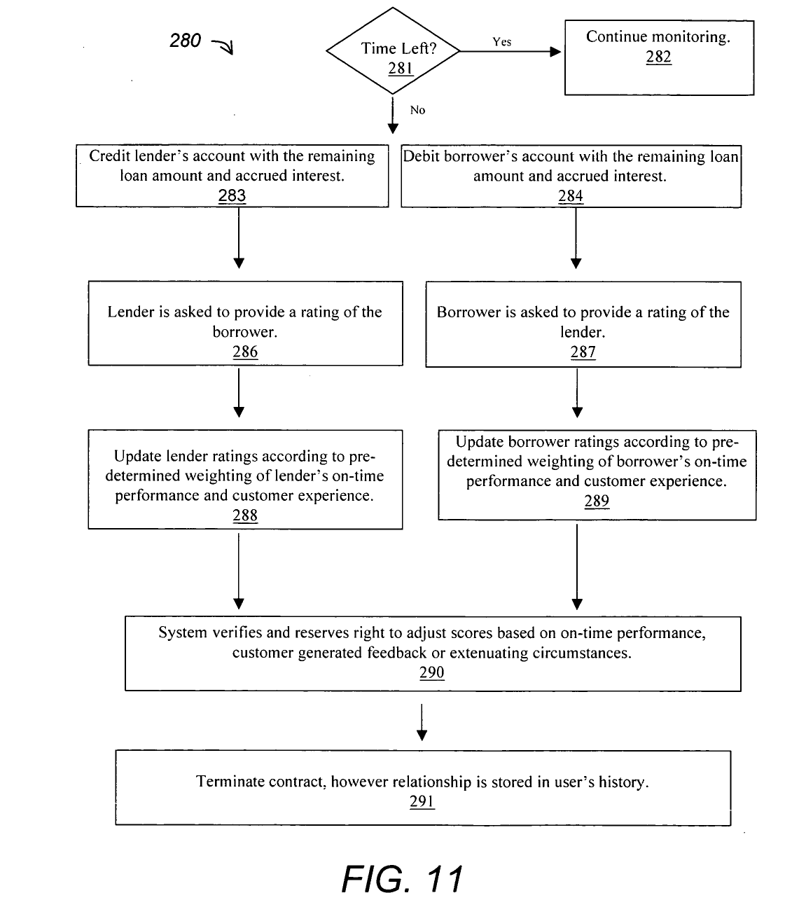

Referring to FIG. 11, the transaction closing process 280 includes:
Once term is finished (281) or loan is ended early, borrower's account is debited with the loan amount plus accrued interest (284) (283).
Lender is asked to provide a rating of the borrower (286).
Borrower is asked to provide a rating of the lender (287).
Lender ratings are updated according to pre-determined weighting of lender's on-time performance and cordiality (288).
Borrower ratings are updated according to pre-determined weighting of borrower's on-time performance and cordiality (289).
System verifies and reserves right to adjust scores based on on-time performance or customer generated feedback (290).
Contract is terminated, however relationship is stored in user's history (291).

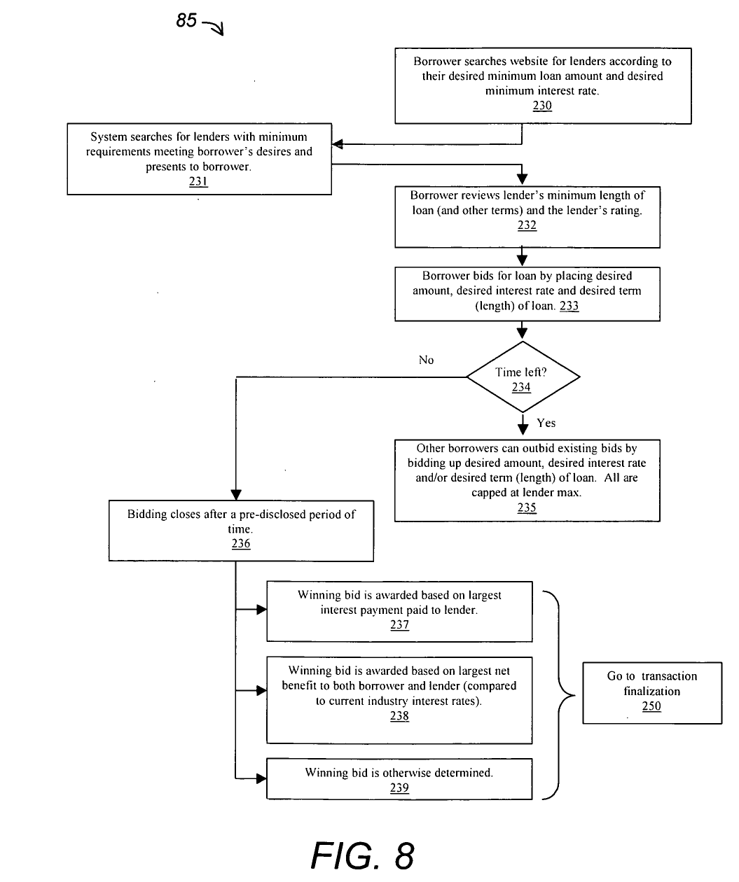

Referring to FIG. 8, the auction based transaction process 85 includes the following:
Borrower searches (auction loan preferred) lenders according to their desired loan amount and desired interest rate (230).
Lenders with minimum requirements meeting borrower's desires are presented to borrower based on system search (231).
Borrower can review lender's minimum length of loan (and other terms) and the lender's rating (232).
Borrower bids for loan by placing desired amount, desired interest rate and desired term (length) of loan (233).
Other borrowers can outbid existing bids by bidding up desired amount, desired interest rate and/or desired term (length or payback period) of loan (235).
Bidding closes after a pre-disclosed (and visible) period of time (236).
Highest winning bid is calculated based on largest interest payment going to lender (237). The auction's winning bid calculation algorithm reserves the right to base winning bid on net benefit to both borrower and lender (238) (as compared to industry interest rates), or as otherwise determined (239).
Lender may approve borrower.

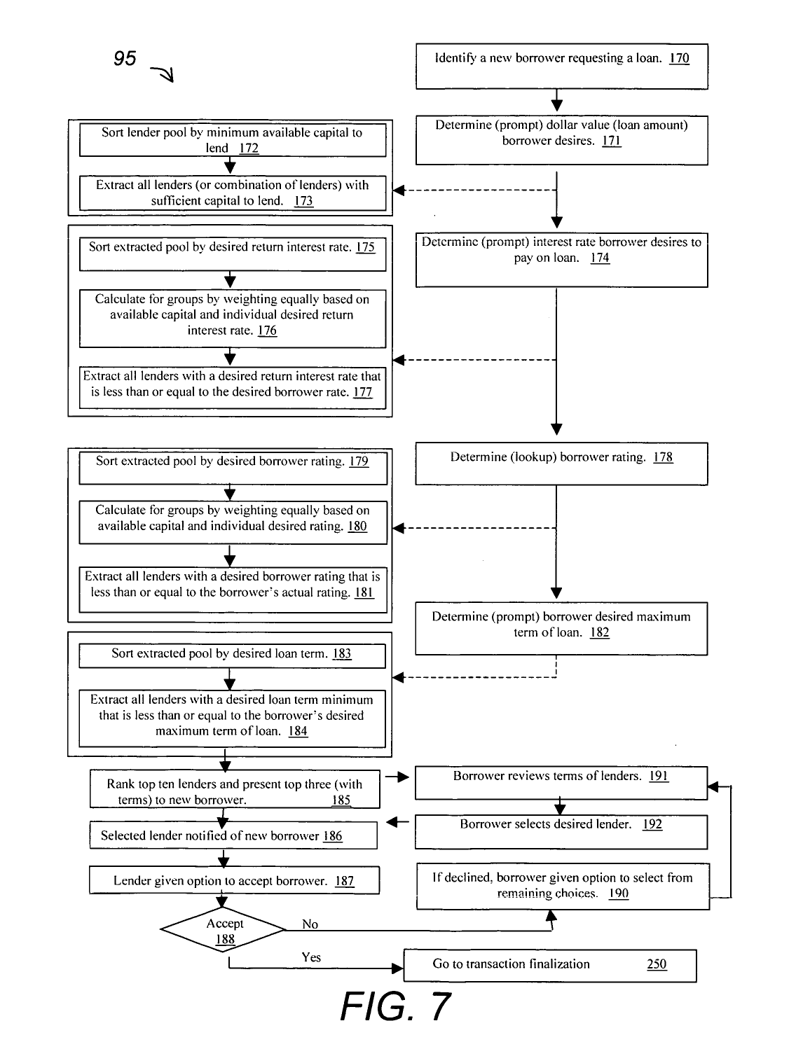

Referring to FIG. 7, the algorithm based transaction process 95 includes the following:
Identify a new borrower (name and rating) requesting a loan (170).
Determine dollar value (loan amount) borrower desires. (171)
Search lender (algorithm generated loan preferred) pool (sorted by minimum available capital to lend) (172) and extract all lenders with sufficient capital to lend (173). If one lender is insufficient, select pairs of lenders with sufficient capital.
Determine interest rate borrower desires (174).
Search previously extracted lender pool (sorted by desired rate) (175) and extract all lenders with a desired interest rate that is less than or equal to the desired borrower rate (177). Algorithm reserves the right to select a pre-determined group of lenders by maximizing or minimizing (or otherwise weighting) the spread between desired borrower and lender rates (176). If a pair of lenders exists, their calculated desired interest rate is weighted equally based on available capital and individual desired interest rate.
Determine borrower rating (178).
Search previously extracted lender pool (sorted by desired borrower rating) (179) and extract all lenders with a desired borrower rating that is less than or equal to the borrower's actual rating (181). If a pair of lenders exists, their calculated desired rating is weighted equally based on available capital and individual desired rating (180).
Determine borrower desired maximum term of loan (borrower can choose to forgo this step) (182).
Search extracted lender pool (sorted by desired loan term) (183) and extract all lenders with a desired loan term minimum that is less than or equal to the borrower's desired maximum term of loan (184).
Rank top ten (or more) lenders and present top three (or more), including name and ranking, to new borrower (185).
Borrower reviews terms of lender (191).
Borrower selects desired lender (192).
Selected lender notified of new borrower (186).
Lender given option to decline borrower (187). If declined, borrower given option to select two (or more) remaining choices as well as one more (or more) which is stored and automatically generated (190).
Process continues until a lender approves of borrower or until remainder of ranked lenders disapproves of borrower.

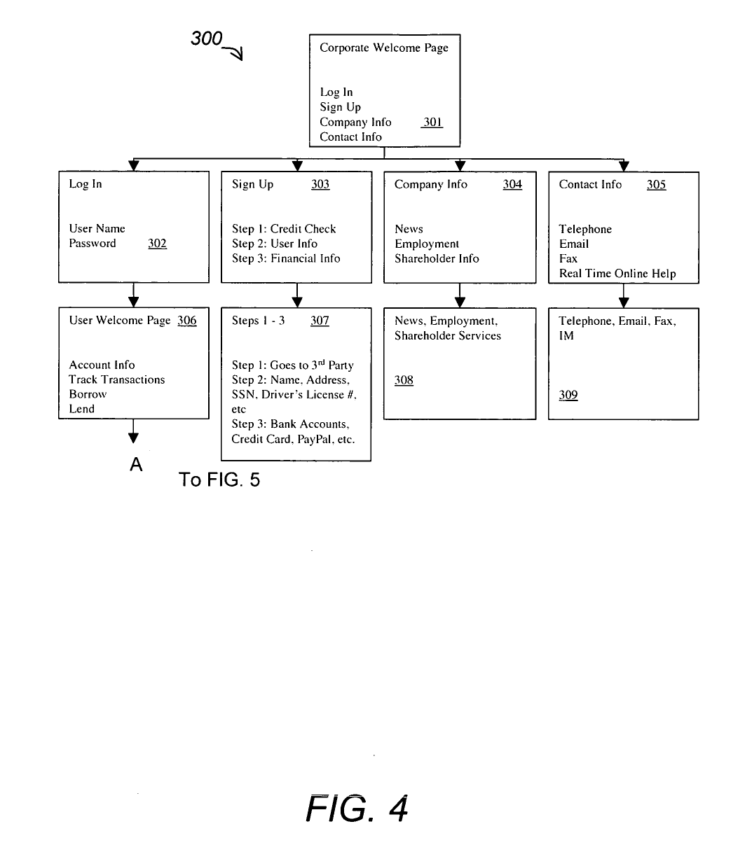

Referring to FIG. 4, welcome page (301) of the banking website (300) includes a log in button, a sign up button, company information and contact information, among others. The log in button leads to a page that asks the user to enter a user name and a password (302). A successful login leads to a user welcome page (306), that includes the user's account information button, track transactions button, borrow and lend function buttons. The sign up button leads a first time user to a webpage that includes a credit check, a request form for user information, and financial information (303). The credit check step is performed by a third party, such as Equifax. The user information form includes fields for user's name, address, phone number, e-mail, driver's license, and social security number, among others. The financial information includes the user's bank accounts, credit cards, PayPal™ account, among others (307). The company information includes news, employment, and shareholder information and services (304), (308). The contact information includes telephone numbers, e-mail addresses, fax numbers, and real time online help, such as instant messaging (IM), among others (305), (309).

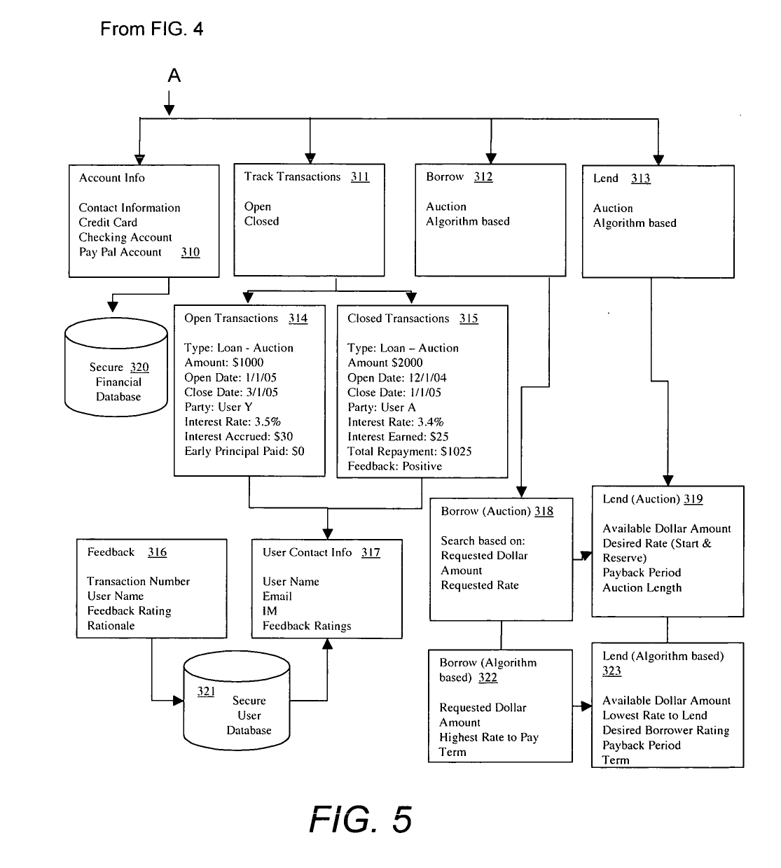

Referring to FIG. 5, the user's account information page (310) includes his contact information, credit card numbers, checking accounts, and PayPal™ accounts (310). This information is stored in a secure financial database (320). The track transactions button (311) includes open and closed transactions buttons. The open transactions button (314) leads to a page that lists all open transactions including information about type of loan, amount of loan, open date, close date, name of party, interest rate, interest accrued, and principal paid. The closed transactions button (315) leads to a page that lists all closed transactions including information about type of loan (i.e., auction), amount of loan, open date, close date, name of party, interest rate, interest earned, total payments, and feedback. Feedback information per transaction includes the transaction number, user's name, feedback rating and rationale (316). This feedback information is stored in a secure database (321) and is provided upon request through the transactions page (317). The borrow button leads to the borrow page (312) which includes an auction button and an algorithm-matched button. The auction button starts a search based on requested amount and rate (318). The algorithm-matched button includes the requested amount and the highest rate to pay and term (322). The lend button leads to the lend page (313) which includes an auction button and an algorithm-matched button. The auction button leads to the auction page that includes the available amount offered for lending, the desired rate (start and reserve), payback period, and auction length (319). The algorithm-matched button leads to the algorithm-matched page that includes the available amount, the lowest rate willing to lend, desired borrower rating and payback period (323).

The benefits of this invention include lower borrower rates (for example, as compared to credit cards), higher lender rates (for example, as compared to certificate of deposits or savings accounts), and potentially lower transaction costs for both parties. From a revenue generating standpoint, a fee is charged to the lender, seller or both parties for each Internet based transaction, either fixed or based on the value of money that trades hands.

This invention need not be limited to peer-to-peer transactions. It can be used to match one or multiple borrowers and lenders for all levels of finance to include personal, government, and corporate transactions. In fact, one borrower can have multiple lenders or one lender can have multiple borrowers. Business-to-Business, Business to Peer and Peer to Business are three other potential uses.

Security for the system and the financial transactions and information is provided by encrypting the website with the latest technology. User names (i.e. User X) replace numerical tracking (i.e. credit card number).

Fraudulent users are prevented via the following measures:
To sign up for use of this service, all users must pass a successful credit check, performed by a third party.
In addition, users must provide at least three forms of identification (to include SSN, driver's license number, credit card, bank account number, etc.) to verify identity.
All contracts between users are federal and state law binding. Terms of the contract are as standard as possible and include specific state amendments as necessary. All users may have the option to terminate a contract early, and pay any accrued interest as well as a ‘pre-determined’ penalty fee to other contract holders and auction providers. In addition, late payment of interest generates penalty fees and additional interest for delinquent borrowers (as pre-determined by the lender). The contracts specify that the loan provider has the right to employ collection agencies and confiscate property, garner future wages, etc. to meet the terms of the loan in case of a delinquent loan repayment.
In the case of fraud, a loan guarantor can insure the loan repayment, for a specified rate. The users do not see the loan guarantor, rather the loan guarantor price is factored into the interest rates.
The process and system of this invention may seek FDIC approval.

Several embodiments of the present invention have been described. Nevertheless, it will be understood that various modifications may be made without departing from the spirit and scope of the invention. Accordingly, other embodiments are within the scope of the following claims.

What is claimed is:

1. A method for providing a peer-to-peer loan service comprising:
providing a website wherein said website is accessible via a network connection and comprises a plurality of interlinked webpages stored in a memory and said memory is couple to a computing circuit and to a communications interface for communicating via said network connection;
listing one or more lenders, and amount of capital offered to be loaned and loan terms for each of said one or more lenders in a lender database;
placing a bid for a desired loan amount and desired loan terms by a borrower in said website;
identifying at least one lender among said one or more lenders who can meet said borrower's bid and communicating information of said at least one lender to said borrower;
selecting said at least one lender by said borrower and notifying said selected at least one lender of said borrower's bid; and
reaching of equilibrium agreement between said at least one lender and said borrower.

2. The method of claim 1 further comprising accepting said borrower's bid by said at least one lender.

3. The method of claim 1 wherein said loan terms comprise interest rate, maximum payback period of loan, repayment terms, early termination penalties and interest rate fluctuations.

4. The method of claim 1 wherein said identifying of at least one lender who can meet said borrower's bid occurs via an algorithm and wherein said algorithm receives input variables selected from a group consisting of lender's lowest acceptable loan amount, borrower's dynamic risk level based on credit rating and prior feedback, borrower's desired principle loan amount, borrower's highest potential interest rate, lender's lowest potential interest rate and lowest potential loan amount, lender's desired payback period of loan, and lender's credit rating and prior feedback.

5. The method of claim 4 wherein said algorithm further provides loan interest rates based on a risk assessment calculation.

6. The method of claim 4 wherein said algorithm performs calculation steps comprising:
identifying said borrower;
determining desired loan amount, desired loan terms, and borrower's credit rating;
searching said lender database and extracting all lenders with sufficient amount of capital meeting said desired loan amount, desired loan terms, and borrower's credit rating;
ranking lenders meeting said desired loan amount, desired loan terms, and borrower's credit rating; and
presenting said ranked lenders to said borrower.

7. The method of claim 1 wherein said reaching of equilibrium agreement between said at least one lender and said borrower occurs via an auction process.

8. The method of claim 7 wherein said auction process comprises receiving and posting said borrower's bid;
receiving and posting additional bids from other borrowers for said desired loan amount and said desired loan terms;
closing of the bidding process after a pre-disclosed period of time; and
determining a winning bid based on criteria selected from a group consisting of greatest amount of interest going to the lender, greatest net benefit going to both borrower and lender as compares to current interest rates, loan terms, loan amount, credit ratings and feedback of borrowers.

9. The method of claim 1 further comprising collecting information about said lenders and said borrower and pre-approving said lenders and said borrower for participating in said peer-to-peer loan service.

10. The method of claim 9 wherein said information is selected form a group consisting of credit rating, feedback from previous transactions, employment records, health records, residency records, personal assets, educational records, and professional records.

11. The method of claim 1 further comprising presenting a contract for said peer-to-peer loan service to said borrower and said at least one lender.

12. The method of claim 11 further comprising collecting funds for said loan amount from said at least one lender and upon signing said contract by both said borrower and said at least one lender distributing said funds to said borrower.

13. The method of claim 12 further comprising keeping track of all financial transactions comprising said collection and distribution of funds, repayment of said funds plus interest from said borrower to said at least one lender, and transaction costs.

14. The method of claim 12 further comprising receiving said funds by said borrower via a method selected from a group consisting of credit card, check, direct deposit in a bank account, wire in a bank account and deposit in an electronic account.

15. The method of 12 further comprising paying back said funds to said at least one lender by said borrower and wherein said at least one lender receives said funds via a method selected from a group consisting of credit card, check, direct deposit in a bank account, wire in a bank account and deposit in an electronic account.

16. The method of claim 1 further comprising providing feedback for said borrower and said at least one lender.

17. The method of claim 1 wherein said website comprises a user secure log in webpage, a user secure sign up webpage, a company information webpage, a contact information webpage, and a user welcome webpage.

18. The method of claim 17 wherein said user welcome webpage comprises links to webpages selected from a group consisting of user's account information, track transactions, borrow webpage and lend webpage.

19. The method of claim 18 wherein said user's account information webpage comprises user's contact information, credit card information, bank account information, electronic account information, credit rating and feedback.

20. The method of claim 18 wherein said track transaction webpage comprises all open and closed transaction information.

21. The method of page 18 wherein said borrow webpage and said lend webpage comprise links to an auction based process and an algorithm based process.

22. A system for providing a peer-to-peer loan service comprising:
a website wherein said website is accessible via a network connection and comprises a plurality of interlinked webpages stored in a memory and said memory is couple to a computing circuit and to a communications interface for communicating via said network connection;
means for listing one or more lenders, and amount of capital offered to be loaned and loan terms for each of said one or more lenders in a lender database;
means for placing a bid for a desired loan amount and desired loan terms by a borrower in said website;
means for identifying at least one lender among said one or more lenders who can meet said borrower's bid and communicating information of said at least one lender to said borrower;
means for selecting said at least one lender by said borrower and notifying said selected at least one lender of said borrower's bid; and
means for reaching of equilibrium agreement between said at least one lender and said borrower.

23. The system of claim 22 further comprising means for accepting said borrower's bid by said at least one lender.

24. The system of claim 22 wherein said loan terms comprise interest rate, maximum payback period of loan, repayment terms, early termination penalties and interest rate fluctuations.

25. The system of claim 22 wherein said means for identifying of at least one lender who can meet said borrower's bid comprise an algorithm and wherein said algorithm receives input variables selected from a group consisting of lender's lowest acceptable loan amount, borrower's dynamic risk level based on credit rating and prior feedback, borrower's desired principle loan amount, borrower's highest potential interest rate, lender's lowest potential interest rate and lowest potential loan amount, lender's desired payback period of loan, and lender's credit rating and prior feedback.

26. The system of claim 25 wherein said algorithm further provides loan interest rates based on a risk assessment calculation.

27. The system of claim 25 wherein said algorithm performs calculation steps comprising:
identifying said borrower;
determining desired loan amount, desired loan terms, and borrower's credit rating;
searching said lender database and extracting all lenders with sufficient amount of capital meeting said desired loan amount, desired loan terms, and borrower's credit rating;
ranking lenders meeting said desired loan amount, desired loan terms, and borrower's credit rating; and
presenting said ranked lenders to said borrower.

28. The system of claim 22 wherein said equilibrium between said at least one lender and said borrower is reached via an auction.

29. The system of claim 28 wherein said auction comprises
receiving and posting said borrower's bid;
receiving and posting additional bids from other borrowers for said desired loan amount and said desired loan terms;
closing of the bidding process after a pre-disclosed period of time; and
determining a winning bid based on criteria selected from a group consisting of greatest amount of interest going to the lender, greatest net benefit going to both parties as compares to current interest rates, loan terms, loan amount, credit ratings and feedback of borrowers.

30. The system of claim 22 further comprising means for collecting information about said lenders and said borrower and pre-approving said lenders and said borrower for participating in said peer-to-peer loan service.

31. The system of claim 30 wherein said information is selected form a group consisting of credit rating, feedback from previous transactions, employment records, health records, residency records, personal assets, educational records, and professional records.

32. The system of claim 22 further comprising means presenting a contract for said peer-to-peer loan service to said borrower and said at least one lender.

33. The system of claim 32 further comprising means for collecting funds for said loan amount from said at least one lender and upon signing said contract by both said borrower and said at least one lender distributing said funds to said borrower.

34. The system of claim 32 further comprising means for keeping track of all financial transactions comprising said collection and distribution of funds, repayment of said funds plus interest from said borrower to said at least one lender, and transaction costs.

35. The system of claim 33 further comprising means for receiving said funds by said borrower via a system selected from a group consisting of credit card, check, direct deposit in a bank account, wire in a bank account, and deposit in an electronic account.

36. The system of claim 33 further comprising means for paying back said funds to said at least one lender by said borrower and wherein said at least one lender receives said funds via a system selected from a group consisting of credit card, check, direct deposit in a bank account, wire in a bank account and deposit in an electronic account.

37. The system of claim 22 further comprising means for providing feedback for said borrower and said at least one lender.

38. The system of claim 22 wherein said website comprises a user secure log in webpage, a user secure sign up webpage, a company information webpage, a contact information webpage, and a user welcome webpage.

39. The system of claim 38 wherein said user welcome webpage comprises links to webpages selected from a group consisting of user's account information, track transactions, borrow webpage and lend webpage.

40. The system of claim 39 wherein said user's account information webpage comprises user's contact information, credit card information, bank account information, electronic account information, credit rating and feedback.

41. The system of claim 39 wherein said track transaction webpage comprises all open and closed transaction information.

42. The system of claim 39 wherein said borrow webpage and said lend webpage comprise links to an auction and an algorithm.

43. The method of claim 1 further comprising providing a loan guarantor for said desired loan.
